(19) United States
(12) Patent Application Publication
(10) Pub. No.: US 2013/0211820 A1
(43) Pub. Date: Aug. 15, 2013

(54) APPARATUS AND METHOD FOR INTERPRETING KOREAN KEYWORD SEARCH PHRASE

(71) Applicant: Electronics and Telecommunications Research Institute, (US)

(72) Inventors: Joon Myun CHO, Daejeon (KR); Moo Hun LEE, Daejeon (KR)

(73) Assignee: Electronics and Telecommunications Research Institute, Daejeon (KR)

(21) Appl. No.: 13/768,044

(22) Filed: Feb. 15, 2013

(30) Foreign Application Priority Data
Feb. 15, 2012 (KR) 10-2012-0015109

(51) Int. Cl. G06F 17/28

(52) U.S. Cl. CPC G06F 17/289
USPC 704/4

(57) ABSTRACT

An apparatus and method for interpreting a Korean keyword search phrase is provided. The apparatus for interpreting the Korean keyword search phrase may include an interface to receive a search phrase and to extract keywords from the search phrase, and a processor to classify the extracted keywords into at least one of a class, an instance, a property, and an attribute, based on a Korean sentence structure, and to obtain semantic information associated with the search phrase from a database, based on a result of the classifying.

### CROSS-REFERENCE TO RELATED APPLICATION

This application claims the benefit of Korean Patent Application No. 10-2012-0015109, filed on Feb. 15, 2012, in the Korean Intellectual Property Office, the disclosure of which is incorporated herein by reference.

### BACKGROUND

1. Field of the Invention

The present invention relates to a technology for providing more accurate semantic information associated with an input search phrase, by interpreting the search phrase based on a Korean sentence structure.

2. Description of the Related Art

In a conventional search scheme of a web search engine, interpreting a meaning of a search phrase that is indicated based on a relationship between keywords may be unnecessary since documents including keywords matching keywords input by a user may be simply provided. That is, in the conventional search scheme, keywords included in a search phrase may be compared on an individual basis to contents of documents or metadata of documents, and thus documents including the identical keywords may be returned.

In such a search method, the documents including keywords matching the input keywords may be searched for and provided, without interpreting the meaning of the search phrase. Accordingly, a massive amount of search results may be provided. However, providing search results corresponding to an intention of the user may be difficult.

In this regard, research on a semantic search scheme is actively being conducted in order to overcome limitations of a conventional keyword matching based search scheme. With respect to the semantic search scheme, a method of interpreting a meaning of a search phrase based on a relationship between objects indicated by keywords, and searching for data matching the interpreted meaning is being studied.

In addition, terminals utilized by users to execute search applications has been recently expanded from a personal computer (PC) to terminals having constraints on a sentence input interface, for example, a smart phone, a tablet PC, a smart television (TV), and the like. Since such a terminal does not come with a dedicated keyboard, a search phrase may be input using a QWERTY keyboard displayed on a small screen of the terminal Accordingly, in order to minimize a number of keystrokes, the search phrase may be input by inputting main words excluding a verb, a postposition, an ending, and the like, rather than inputting a complete, natural language sentence. When a search phrase including only main words is input, a search apparatus may face difficulties in interpreting a meaning of the search phrase since information regarding a sentence structure is absent.

### SUMMARY

An aspect of the present invention provides an apparatus and method for obtaining more accurate information desired by a user, by classifying keywords extracted from an input search phrase into at least one of a class, an instance, a property, and an attribute, based on a Korean sentence structure, and obtaining semantic information associated with the search phrase from a database, based on a result of the classifying.

According to an aspect of the present invention, there is provided an apparatus for interpreting a Korean keyword search phrase, the apparatus including an interface to receive a search phrase and to extract keywords from the search phrase, and a processor to classify the extracted keywords into at least one of a class, an instance, a property, and an attribute, based on a Korean sentence structure, and to obtain semantic information associated with the search phrase from a database, based on a result of the classifying.

According to another aspect of the present invention, there is provided a method of interpreting a Korean keyword search phrase, the method including receiving a search phrase and extracting keywords from the search phrase, classifying the extracted keywords into at least one of a class, an instance, a property, and an attribute, based on a Korean sentence structure, and obtaining semantic information associated with the search phrase from a database, based on a result of the classifying.

According to example embodiments of the present invention, a number of cases with respect to a semantic analysis may be reduced by classifying keywords extracted from an input search phrase into at least one of a class, an instance, a property, and an attribute, based on a Korean sentence structure, and obtaining semantic information associated with the search phrase from a database, based on a result of the classifying. Accordingly, more accurate information desired by a user may be obtained and provided. In other words, an apparatus and method according to example embodiments of the present invention may form a single knowledge graph including all objects corresponding to all the keywords, by searching for and associating a relationship, an attribute, or the like omitted between keywords unexpressed in the search phrase obviously. During the foregoing process, the apparatus and method may attempt to associate objects having a relatively high association possibility based on the Korean sentence structure, rather than attempting all possible associations one by one, thereby efficiently performing a semantic analysis with respect to a Korean keyword search phrase.

Accordingly, when a search keyword is received using a limited QWERTY keyboard of a smart phone, more accurate information about search results may be provided by reinterpreting a meaning of the search keyword.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an apparatus for interpreting a Korean keyword search phrase according to an embodiment of the present invention; and

FIG. 2 is a flowchart illustrating a method of interpreting a Korean keyword search phrase according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

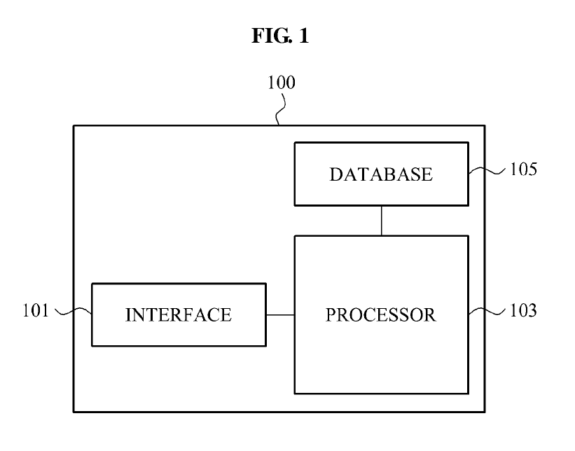

FIG. 1 is a diagram illustrating an apparatus 100 for interpreting a Korean keyword search phrase according to an embodiment of the present invention.

Referring to FIG. 1, the apparatus 100 may include an interface 101, a processor 103, and a database 105.

The interface 101 may receive a search phrase, and may extract keywords from the search phrase. For example, when a search phrase of “Angelina Jolie starring horror movie” is input, the interface 101 may extract keywords “Angelina Jolie,” “starring,” “horror,” and “movie” from the search phrase.

Here, the interface 101 may receive an input of a search phrase including at least one keyword that may be classified as a class. In this instance, the search phrase may include the keyword that is classified as the class, as a keyword positioned at the end of the search phrase.

For example, the processor 103 may provide semantic information associated with the search phrase through a display unit (not shown), by classifying the extracted keywords into at least one of a class, an instance, a property, and an attribute of the instance, based on a Korean sentence structure, and obtaining the semantic information from the database 105 based on a result of the classifying. Here, the semantic information associated with the search phase may correspond to, for example, knowledge information associated with instances extracted from the database 105 as a result. For example, with respect to the keywords “Angelina Jolie,” “starring,” “horror,” and “movie” that are extracted from the search phrase of “Angelina Jolie starring horror movie,” the processor 103 may classify “Angelina Jolie” as the instance, “starring” as the property, “horror” as the attributes, and “movie” as the class, based on the Korean sentence structure. Here, the Korean sentence structure may correspond to, for example, a structure in which a subject and an object are placed before a verb, and a modifier is placed before a modificand that is modified by the modifier.

In particular, the processor 103 may extract, from the database 105, first instances included in a class corresponding to a class keyword classified as the class, extract, from the extracted first instances, second instances related to an instance corresponding to an instance keyword classified as the instance, and obtain, as the semantic information, information associated with the extracted second instances, or document information partially including the extracted second instances. For example, the processor 103 may extract first instances included in the class of “movie” from the database 105, extract second instances related to the instance of “Angelina Jolie” from the extracted first instances, and obtain information associated with the extracted second instance as the semantic information.

In this instance, when a property keyword classified as the property is present, the processor 103 may extract, from the extracted first instances, the second instances related to instances corresponding to the instance keyword in terms of a property corresponding to the property keyword. For example, the processor 103 may extract, from the first instances included in the class of “movie,” the second instances related to the instance of “Angelina Jolie” in terms of the property of “starring” indicating a relationship.

In addition, when an attribute keyword classified as the attributes is present, the processor 103 may extract attribute instances corresponding to the attribute keyword from the second instances, and may obtain information associated with the extracted attribute instances as the semantic information. For example, the processor 103 may extract instances corresponding to the attribute of “horror” from the second instances related to the instance of “Angelina Jolie” in terms of the property of “starring” indicating a relationship, and may obtain information associated with the extracted instances as the semantic information.

Accordingly, when the search phrase of “Angelina Jolie starring horror movie” is input into the interface 101, the processor 103 may obtain and provide information regarding “a movie corresponding to a horror genre among movies starring Angelina Jolie.” That is, although a search keyword is received using, for example, a limited QWERTY keyboard of a smart phone, the processor 103 may provide more accurate information about search results by reinterpreting a meaning of the search keyword.

When a plurality of keywords, among the extracted keywords, is classified as the class, the processor 103 may classify keywords input prior to a first keyword, and the first keyword as a first single search phrase, and may classify keywords input between the first keyword and a second keyword, and the second keyword as a second single search phrase. For example, when a search phrase of “Gran Torino director starring drama film” is input into the interface 101, the processor 103 may classify keywords “director,” and “film” extracted from the search phrase as the class. In this instance, since a plurality of keywords is classified as the class, the processor 103 may classify a keyword “Gran Torino” input prior to a first keyword “director”, and the first keyword “director”, that is, “Gran Torino director” as a first single search phrase, and may classify keywords “starring” and “drama” input between the first keyword “director” and a second keyword “film”, and the second keyword “film”, that is, “starring drama film” as a second single search phrase.

The processor 103 may extract, from the database 105, first instances associated with the first single search phrase, and second instances associated with the second single search phrase, extract third instances related to the first instances from the second instances, and obtain information associated with the extracted third instances as the semantic information. For example, the processor 103 may extract instances related to an instance of “Gran Torino” from instances included in the class of “director,” as first instances associated with the first single search phrase of “Gran Torino director,” and may extract instances included in the class of “film” as second instances associated with the second single search phrase of “starring drama film.” The processor 103 may extract third instances related to the first instances from the second instances, as a property of “starring,” extract instances corresponding to an attribute of “drama” from the extracted third instances, and obtain information associated with the extracted instances as the semantic information.

As another example, when a keyword search phrase input by a user is segmented into a plurality of single search phrases, the processor 103 may process each of the plurality of search phrases according to the present embodiment. Here, the processor 103 may interpret a meaning of a single search phrases based on logical cases using a Korean sentence structure, rather than considering all interpretable cases, thereby reducing an amount of time used to interpret the meaning and increasing an accuracy of a search result. For example, in general, with respect to a single search phrase “Angelina Jolie starring horror movie,” the processor 103 may consider keywords “Angelina Jolie,” “starring,” “horror,” and the like as a plurality of objects, as opposed to a single knowledge base object. Accordingly, all possible cases for all knowledge objects may be candidate targets for the interpreting. However, the processor 103 may configure a knowledge graph for only logical cases, rather than considering all possible cases, based on characteristics of the Korean sentence structure, the characteristics including a modifier being placed before a modificand that is modified by the modifier, a subject and an object being placed before a verb, a verb not being used without a subject or an object being placed before the verb, and the like. For example, the processor 103 may classify the keyword “movie” in the single search phrase “Angelina Jolie starring horror movie” as a class object, and may not classify the keywords “Angelina Jolie,” “starring,” and “horror” as the class. The processor 103 may classify at least the foremost keyword “Angelina Jolie” as an instance object since a word corresponding to a verb may not be used solely without a subject or an object being placed before the verb. In addition, when the foremost keyword “Angelina Jolie” is not classified as the instance object, such as an adjective “red” in “red apple,” the processor 103 may consider “Angelia Jolie” as an attribute object, as least. The processor 103 may exclude a great portion of cases from all possible cases in which each keyword is map to a plurality of knowledge base objects, and the plurality of knowledge base objects are combined with each other, by applying the characteristics of the Korean sentence structure. Accordingly, the processor 103 may reduce an amount of time to be used for the interpreting, and may increase an accuracy of a search result by excluding illogical cases from a result of the interpreting.

The database 105 may store information presented in a form of a graph formed by a node and an edge, for example, a knowledge graph. Here, the class or the instance may be expressed using the node, and the property may be expressed using an edge connecting instances, or an edge connecting an instance and a class. In addition, the attribute may be expressed by a value assigned to a node corresponding to the instance. In this instance, a single property, that is, a membership property, may be expressed using the edge connecting the instance and the class.

The database 105 may further include knowledge information associated with each instance.

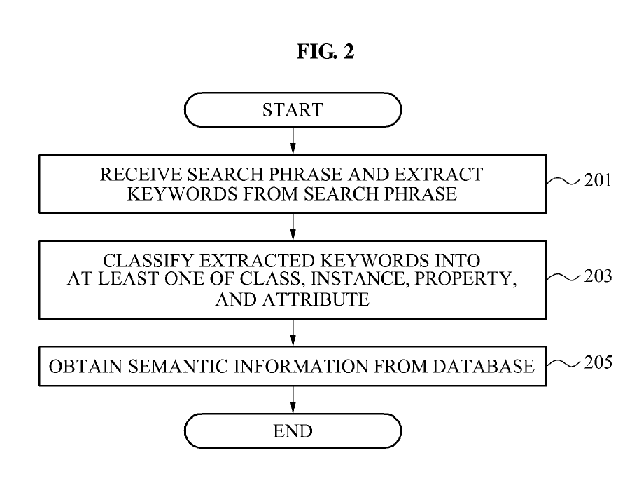

FIG. 2 is a flowchart illustrating a method of interpreting a Korean keyword search phrase according to an embodiment of the present invention. Here, the method of FIG. 2 may be performed by the apparatus 100 for interpreting a Korean keyword search phrase.

Referring to FIG. 2, in operation 201, the apparatus 100 may receive a search phrase, and may extract keywords from the search phrase.

In operation 203, the apparatus 100 may classify the extracted keywords into at least one of a class, an instance, a property, and an attributes, based on a Korean sentence structure.

In operation 205, the apparatus 100 may obtain and provide semantic information associated with the search phrase from a database, based on a result of the classifying.

In particular, the apparatus 100 may extract, from the database, first instances included in a class corresponding to a class keyword classified as the class, extract, from the extracted first instances, second instances related to an instance corresponding to an instance keyword classified as the instance, and obtain information associated with the extracted second instances, as the semantic information.

In this instance, when a property keyword classified as the property is present, the apparatus 100 may extract, from the extracted first instances, the second instances related to instances corresponding to the instance keyword in terms of a property corresponding to the property keyword.

In addition, when an attribute keyword classified as the attributes is present, the apparatus 100 may extract attribute instances corresponding to the attribute keyword from the second instances, and may obtain information associated with the extracted attribute instances as the semantic information.

When a plurality of keywords, among the extracted keywords, is classified as the class, the apparatus 100 may classify keywords input prior to a first keyword, and the first keyword as a first single search phrase, and may classify keywords input between the first keyword and a second keyword, and the second keyword as a second single search phrase. The apparatus 100 may extract, from the database, first instances associated with the first single search phrase, and second instances associated with the second single search phrase, extract third instances related to the first instances from the second instances, and obtain information associated with the extracted third instances as the semantic information.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for interpreting a Korean keyword search phrase, the apparatus comprising:
an interface to receive a search phrase and to extract keywords from the search phrase; and
a processor to classify the extracted keywords into at least one of a class, an instance, a property, and an attribute, based on a Korean sentence structure, and to obtain semantic information associated with the search phrase from a database, based on a result of the classifying.

2. The apparatus of claim 1, wherein the processor extracts, from the database, first instances included in a class corresponding to a class keyword classified as the class, extracts, from the extracted first instances, second instances related to an instance corresponding to an instance keyword classified as the instance, and obtains information associated with the extracted second instances as the semantic information.

3. The apparatus of claim 2, wherein, when a property keyword classified as the property is present, the processor extracts, from the extracted first instances, the second instances related to instances corresponding to the instance keyword in terms of a property corresponding to the property keyword.

4. The apparatus of claim 2, wherein, when an attribute keyword classified as the attribute is present, the processor extracts attribute instances corresponding to the attribute keyword from the second instances, and obtains information associated with the extracted attribute instances as the semantic information.

5. The apparatus of claim 1, wherein, when a plurality of keywords, among the keywords, is classified as the class, the processor classifies keywords input prior to a first keyword, and the first keyword as a first single search phrase, and classifies keywords input between the first keyword and a second keyword, and the second keyword as a second single search phrase.

6. The apparatus of claim 5, wherein the processor extracts, from the database, first instances associated with the first single search phrase, and second instances associated with the second single search phrase, extracts, from the extracted second instances, third instances related to the first instances, and obtains information associated with the extracted third instances as the semantic information.

7. A method of interpreting a Korean keyword search phrase using a Korean sentence structure, the method comprising:
receiving a search phrase and extracting keywords from the search phrase;
classifying the extracted keywords into at least one of a class, an instance, a property, and an attribute, based on the Korean sentence structure; and
obtaining semantic information associated with the search phrase from a database, based on a result of the classifying.

8. The method of claim 7, wherein the obtaining comprises:
extracting, from the database, first instances included in a class corresponding to a class keyword classified as the class, and extracting, from the extracted first instances, second instances related to an instance corresponding to an instance keyword classified as the instance; and
obtaining information associated with the extracted second instances as the semantic information.

9. The method of claim 8, wherein the extracting of the second instances comprises extracting, from the extracted first instances, the second instances related to instances corresponding to the instance keyword in terms of a property corresponding to the property keyword, when the property keyword classified as the property is present.

10. The method of claim 8, wherein the obtaining of the information associated with the extracted second instances comprises extracting attribute instances corresponding to an attribute keyword from the second instances, and obtaining information associated with the extracted attribute instances as the semantic information, when the attribute keyword classified as the attribute is present.

11. The method of claim 7, further comprising:
classifying keywords input prior to a first keyword, and the first keyword as a first single search phrase, and classifying keywords input between the first keyword and a second keyword, and the second keyword as a second single search phrase, when a plurality of keywords, among the keywords, is classified as the class.

12. The method of claim 11, wherein the obtaining of the semantic information comprises extracting, from the database, first instances associated with the first single search phrase, and second instances associated with the second single search phrase, extracting, from the extracted second instances, third instances related to the first instances, and obtaining information associated with the extracted third instances as the semantic information.
